(19) United States
(12) Patent Application Publication
(10) Pub. No.: US 2019/0335870 A1
(43) Pub. Date: Nov. 7, 2019

(54) HAIR ROLL ATTACHED MIRROR

(71) Applicant: Chan Soo KIM, Seoul (KR)

(72) Inventor: Chan Soo KIM, Seoul (KR)

(21) Appl. No.: 16/294,742

(22) Filed: Mar. 6, 2019

(30) Foreign Application Priority Data
May 3, 2018 (KR) 10-2018-0051347

(51) Int. Cl. A45D 2/14; G02B 7/182; A45D 2/12; A45D 42/04

(52) U.S. Cl. CPC A45D 2/145; A45D 42/04; A45D 2/122; G02B 7/182

(57) ABSTRACT

Disclosed is a mirror-attached hair roll configured such that the waved hair can be immediately checked and arranged through the mirror attached to the hair roll after forming a wavy bang using the hair roll. The mirror-attached hair roll includes a body part around which hair is wound, and a mirror part formed on one side of the body part so as to be visible from the outside.

### CROSS-REFERENCE TO RELATED APPLICATION

This application claims priority to and the benefit of Korean Patent Application No. 10-2008-0051347, filed on May 3, 2018, the disclosure of which is incorporated herein by reference in its entirety.

### BACKGROUND

### Field of the Invention

The present invention relates to a hair roll for waving hair, and more particularly, to a mirror-attached hair roll configured such that the waved hair can be immediately checked and arranged through the mirror attached to the hair roll after forming a wavy bang using the hair roll.

### Discussion of Related Art

As known in the art, a hair roll for bangs is particularly used for forming wavy bangs.

Referring to FIG. 2, a hair roll 10 includes a body part 11 having a cylindrical shape and a brush part 12 formed on the outer circumferential surface of the body part 11.

The body part 11 is made of a flexible synthetic resin material, and the brush part 12 serves to fix the rolled hair.

As shown in FIG. 1, the hair roll 10 configured as above is used to roll and fix the bangs. After a predetermined time elapses, the hair roll 10 is pulled out from the hair, and a wavy bang is formed.

In addition, when performing such bang waving, the user checks whether the hair is waved well or not, and looks in the mirror in order to arrange the waved hair.

However, in order to look in the mirror, the user is required to be in a place where the mirror is installed or to hold the mirror by hand.

The present invention has been devised in view of the above.

### PRIOR ART LITERATURE

### Patent Document

(Patent Document 1) Utility Model Publication No. 20-2018-0000002, Patent Application Publication No. 10-2016-0041578, Utility Model Publication No. 20-2016-0002780, and Patent Application Publication No. 10-2017-0112733

### SUMMARY OF THE INVENTION

### Problem to be Solved by the Invention

The present invention devised under the above-mentioned background is directed to a mirror-attached hair roll configured such that the waved hair can be immediately checked and arranged through the mirror attached to the hair roll after forming a wavy bang using the hair roll.

### Means for Solving the Problem

According to an aspect of the present invention, there is provided a mirror-attached hair roll including a body part around which hair is wound, and a mirror part formed on one side of the body part so as to be visible from the outside.

According to another aspect of the present invention, there is provided a mirror-attached hair roll including a body part around which hair is wound, a brush part formed on an outer circumferential surface of the body part to hold the hair, and a mirror part formed on one side of the body part so as to be visible from the outside.

According to another aspect of the present invention, there is provided a mirror-attached hair roll including a body part having a through hole and allowing hair to be wound therearound, and a mirror part formed on the through hole of the body part so as to be visible from the outside.

According to another aspect of the present invention, there is provided a mirror-attached hair roll including a body part having a through hole, hair being wound around the body part, a brush part formed on an outer circumferential surface of the body part to hold the hair, and a mirror part formed on the through hole of the body part so as to be visible from the outside.

According to the present invention, the body part is cylindrical, and the mirror is circular.

According to the present invention, the mirror part includes a first mirror part and a second mirror part at opposite ends of the body part.

According to the present invention, the mirror part is fixed to the through hole of the body part through a fixing part. The fixing part includes a circular body provided with a seating groove formed on an inner side of the body, the mirror part being seated in and fixed to the seating groove, and a plurality of engagement protrusions formed on a rim of the body.

### Effects of Invention

As described above, the present invention provides user convenience by enabling the user to immediately check and arrange the waved hair through a mirror attached to a hair roll after forming a wavy bang using the hair roll.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view showing a state of use of a typical hair roll;

FIG. 2 is a configuration view of a conventional hair roll;

FIG. 3 is a configuration view of a mirror-attached hair roll according to the present invention;

FIG. 4 is a side cross-sectional view of FIG. 3;

FIG. 5 is a side cross-sectional view according to another embodiment of the present invention;

FIG. 6 is a structural view of a fixing part according to the present invention; and

FIG. 7 is a view showing a state of use of the mirror-attached hair roll according to the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

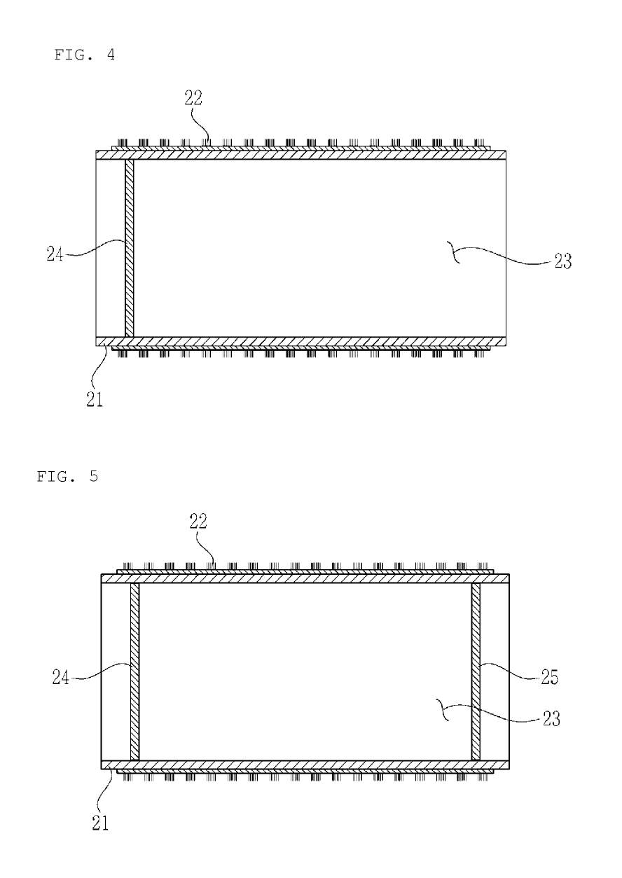

FIG. 3 is a configuration view of a mirror-attached hair roll according to the present invention, and FIG. 4 is a side cross-sectional view of FIG. 3.

As shown in the figures, the hair roll 20 of the present invention includes:

a body part 21 around which hair is wound, and a mirror part 24 formed on one side of the body part 21 so as to be visible from the outside.

The body part 21 may be cylindrical, and the mirror 24 may be circular. However, the present invention is not limited thereto.

Alternatively, the hair roll 20 of the present invention includes:

a body part 21 around which hair is wound, a brush part 22 formed on an outer circumferential surface of the body part 21 to hold the hair, and a mirror part 24 formed on one side of the body part 21 so as to be visible from the outside.

The body part 21 may be cylindrical, and the mirror 24 may be circular. However, the present invention is not limited thereto.

Alternatively, the hair roll 20 of the present invention includes:

a body part 21 having a through hole 23 and allowing hair to be wound therearound, and a mirror part 24 formed on the through hole 23 of the body part 21 so as to be visible from the outside.

The body part 21 may be cylindrical, and the mirror 24 may be circular. However, the present invention is not limited thereto.

Alternatively, the hair roll 20 of the present invention includes:

a body part 21 having a through hole 23, hair being wound around the body part, a brush part 22 formed on an outer circumferential surface of the body part 21 to hold the hair, and a mirror part 24 formed on the through hole 23 of the body part 21 so as to be visible from the outside.

The body part 21 may be cylindrical, and the mirror 24 may be circular. However, the present invention is not limited thereto.

According to the present invention, in the case where the body part 21 does not have the through hole 23, the mirror part 24 is attached to the surface of one side end of the body part 21. In the case where the body part 21 has the through hole 23, the mirror part 24 is fixedly arranged on the inner surface of the through hole 23 at one side end of the body part 21.

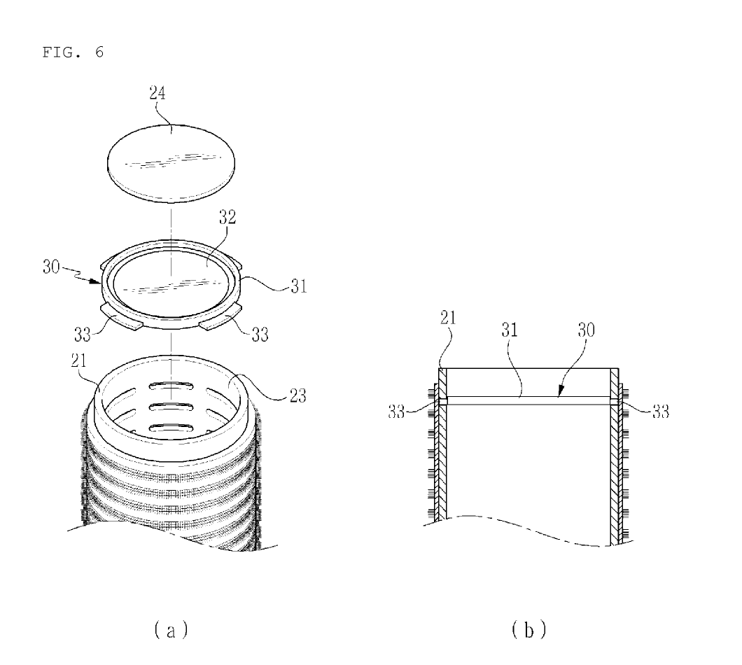

According to another embodiment of the present invention, the mirror part 24 may include two mirror parts at opposite ends of the through hole 23 of the body part 21 as shown in FIG. 5, namely, a first mirror part 24 and a second mirror part 25.

When the two mirror parts 24 and 25 are arranged on the body part 21 without the through hole 23, the two mirror parts 24 and 25 are attached to surfaces of opposite side ends of the body part 21.

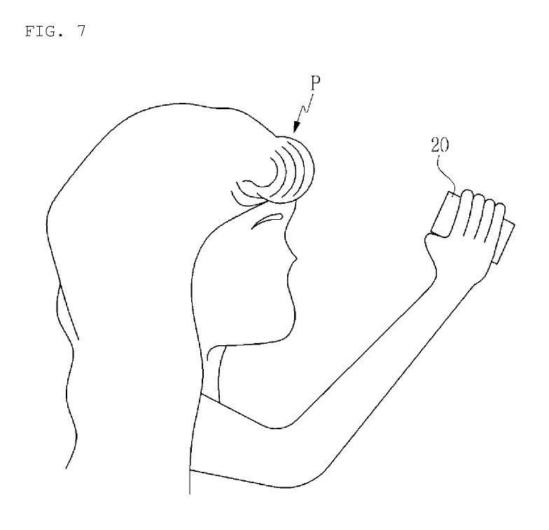

According to the present invention, the mirror part 24 may be fixedly arranged in the through hole 23 of the body part 21 through a separate fixing part 30 as shown in FIG. 6.

As shown in FIG. 6(a), the fixing part 30 includes a circular body 31 provided with a seating groove 32 formed on an inner side of the body 31, the mirror part 24 being seated in and fixed to the seating groove 32, and a plurality of engagement protrusions 33 formed on a rim of the body 31.

The fixing part 30 configured as above is fixed as the engagement protrusions 33 are engaged with the inner surface of the through hole 23 of the body part 21 of the hair roll 20, as shown in FIG. 6(b).

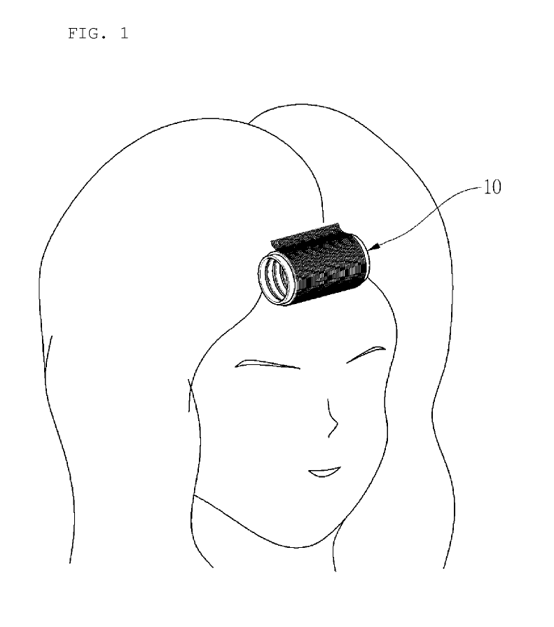

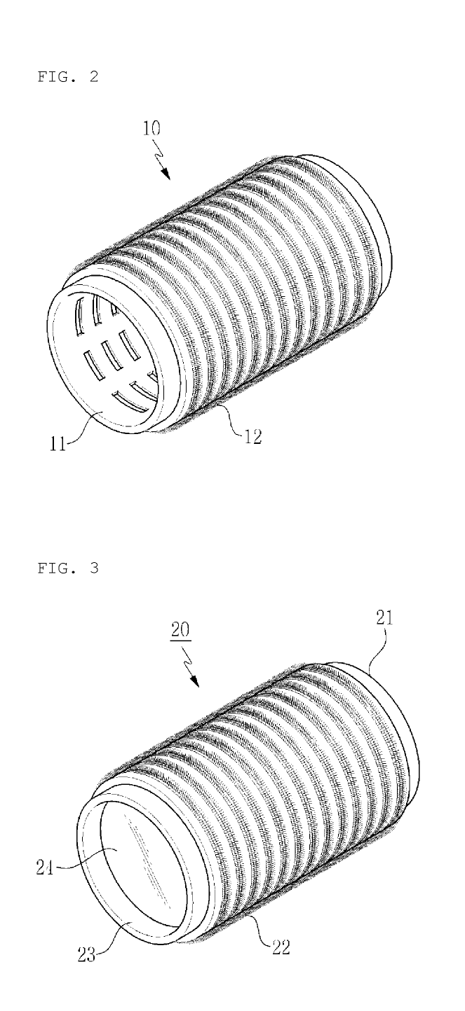

As shown in FIG. 1, the bangs are rolled around the hair roll 20 of the present invention configured as above and fixed, as shown in FIG. 1. Then, when a predetermined time elapses, the user removes the hair roll from the hair such that the bangs take a uniform wave form P. Thereafter, as shown in FIG. 7, the user can check the wave form P through the mirror part 24 attached to the hair roll 20 and easily arrange the wave form.

As described above, the present invention provides user convenience by enabling the user to immediately check and arrange the wavy hair through a mirror attached to a hair roll after forming a wavy bang using the hair roll.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

What is claimed is:

1. A mirror-attached hair roll comprising:
a body part around which hair is wound in a roll shape; and
a mirror part arranged at an end of one of opposite side surfaces of the body part so as to be visible from outside.

2. The mirror-attached hair roll of claim 1, wherein the body part is cylindrical and the mirror part is circular.

3. The mirror-attached hair roll of claim 1, wherein the mirror part comprises a first mirror part and a second mirror part arranged at opposite ends of the body part.

4. A mirror-attached hair roll comprising:
a body part around which hair is wound in a roll shape;
a brush part formed on an outer circumferential surface of the body part to hold the hair; and
a mirror part arranged at an end of one of opposite side surfaces of the body part so as to be visible from outside.

5. The mirror-attached hair roll of claim 4, wherein the body part is cylindrical and the mirror part is circular.

6. The mirror-attached hair roll of claim 4, wherein the mirror part comprises a first mirror part and a second mirror part arranged at opposite ends of the body part.

7. A mirror-attached hair roll comprising:
a body part having a through hole and allowing hair to be wound therearound in a roll shape; and
a mirror part arranged at an end of one of opposite sides of the through hole of the body part so as to be visible from outside.

8. The mirror-attached hair roll of claim 7, wherein the body part is cylindrical and the mirror part is circular.

9. The mirror-attached hair roll of claim 7, wherein the mirror part comprises a first mirror part and a second mirror part arranged at opposite ends of the body part.

10. The mirror-attached hair roll of claim 7, wherein:
the mirror part is fixed to the through hole of the body part through a fixing part, and
the fixing part comprises:
a circular body provided with a seating groove formed on an inner side of the body, the mirror part being seated in and fixed to the seating groove; and
a plurality of engagement protrusions formed on a rim of the body.

11. A mirror-attached hair roll comprising:
a body part having a through hole and allowing hair to be wound therearound in a roll shape;
a brush part formed on an outer circumferential surface of the body part to hold the hair; and
a mirror part arranged at an end of one of opposite sides of the through hole of the body part so as to be visible from outside.

12. The mirror-attached hair roll of claim 11, wherein the body part is cylindrical and the mirror part is circular.

13. The mirror-attached hair roll of claim 11, wherein the mirror part comprises a first mirror part and a second mirror part arranged at opposite ends of the body part.

14. The mirror-attached hair roll of claim 11, wherein:
the mirror part is fixed to the through hole of the body part through a fixing part, and
the fixing part comprises:
a circular body provided with a seating groove formed on an inner side of the body, the mirror part being seated in and fixed to the seating groove; and
a plurality of engagement protrusions formed on a rim of the body.
